(19) United States
(12) Patent Application Publication
(10) Pub. No.: US 2013/0144764 A1
(43) Pub. Date: Jun. 6, 2013

(54) System, Method, and Apparatus for Assisting Customers with Point-of-Sale Transactions

(71) Applicant: Robert Richard Walling, III, Atlanta, GA (US)

(72) Inventor: Robert Richard Walling, III, Atlanta, GA (US)

(21) Appl. No.: 13/310,782

(22) Filed: Dec. 4, 2011

(51) Int. Cl. G06Q 30/06

(52) U.S. Cl. 705/27.1

(57) ABSTRACT

A system comprising a mobile communication device and an order receiver. The mobile communication device comprises a user interface and a near field communication transmitter. The user interface allows a user to enter, select, or confirm order information. The near field communication transmitter is capable of transmitting order information. The order receiver comprises a near field communication receiver. The near field communication receiver is receptive to the order information transmitted from the mobile communication device.

### FIELD OF THE INVENTION

The invention relates generally to point-of-sale transactions and more specifically to making point-of-sale transactions more efficient with a mobile communication device.

### BACKGROUND OF THE INVENTION

In point-of-sale transactions, it is common for customers to have complicated orders that they know before they arrive at the point-of-sale. For instance, a lunch customer may work in a huge office. The lunch customer may place a lunch order for everyone in the office. The lunch customer may struggle to place the entire order once the lunch customer arrives at the restaurant. Another common scenario is that a customer from a foreign country may want to make a purchase. Language barriers, problems with size conversions, and knowledge of currency values may inhibit the transaction. For instance, a French woman may want to purchase a dress while the French woman is on vacation in the US. The French woman may encounter problems if the French woman does not speak English, does not know how to convert European dress sizes into US dress sizes, and/or does not know how many euros the dress's price in dollars equals. Another common scenario is that a customer makes similar purchases at similar intervals. For instance, a breakfast customer may go to the same fast food restaurant at the same time on the same days of the week. The breakfast customer may order the same breakfast on each instance. The breakfast customer may place an unusual order that is frequently blundered. Accordingly, what is needed in the art is a system, method, and apparatus for assisting customers with purchases at the point-of-sale.

### SUMMARY OF THE INVENTION

Disclosed herein is a system comprising a mobile communication device and an order receiver. The mobile communication device comprises a user interface and a near field communication transmitter. The user interface allows a user to enter, select, or confirm order information. The near field communication transmitter is capable of transmitting order information. The order receiver comprises a near field communication receiver. The near field communication receiver is receptive to the order information transmitted from the mobile communication device.

Disclosed herein is a method comprising: suggesting order information based on at least on of the following factors: location, time, and user profile; receiving confirmation or correction of the suggested order information; and transmitting order information to an order receiver.

Disclosed herein is an order receiver comprising a near field communication receiver. The near field communication receiver is receptive to order information transmitted from a mobile communication device.

Disclosed herein is a mobile communication device comprising a user interface and a near field communication transmitter. The user interface allows a user to enter, select, or confirm order information. The near field communication transmitter is capable of transmitting order information.

The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 illustrates an exemplary embodiment of a system comprising a mobile communication device capable of giving information to an order receiver.

FIG. 2 is a flow diagram illustrating an exemplary embodiment for placing an order with mobile communication device and an order receiver.

FIG. 3 illustrates an exemplary embodiment of a system comprising a mobile communication device receiving order information from multiple sources.

FIG. 4 illustrates an exemplary embodiment of a system comprising a mobile communication device capable of receiving order information from one or more sources and giving information to an order receiver.

FIG. 5 is a flow diagram illustrating an exemplary embodiment for placing an order with a mobile communication device after receiving order information from one or more sources.

FIG. 6 is a flow diagram illustrating an exemplary embodiment for placing an order in a foreign language with a mobile communication device.

FIG. 7 is a flow diagram illustrating an exemplary embodiment for placing an order with a mobile communication device that was predicted and confirmed or predicted and corrected.

### DETAILED DESCRIPTION

The present invention is a system and/or a method that may be used in conjunction with a mobile communication device and an order receiver. A mobile communication device may be, for example, a personal digital assistant (PDA), a cellular phone, a smart phone, a computer, including a laptop computer or a tablet computer, or any known device capable of mobile communication. An order receiver may be any known device capable of communicating with a mobile communication device—for example, another mobile communication device or any known type of computer.

The communication may be one-directional—from a mobile communication device to an order receiver. The communication may also be two-directional—with both a mobile communication device and an order receiver both sending and receiving information. The communication may be through any known network for communications, such as the Internet. The communication may also be direct, such as through a physical connection, radio wave transmission, infrared communication, or any known method of direct communication between communication devices. In an exemplary embodiment, the communication may be through near field communication (NFC).

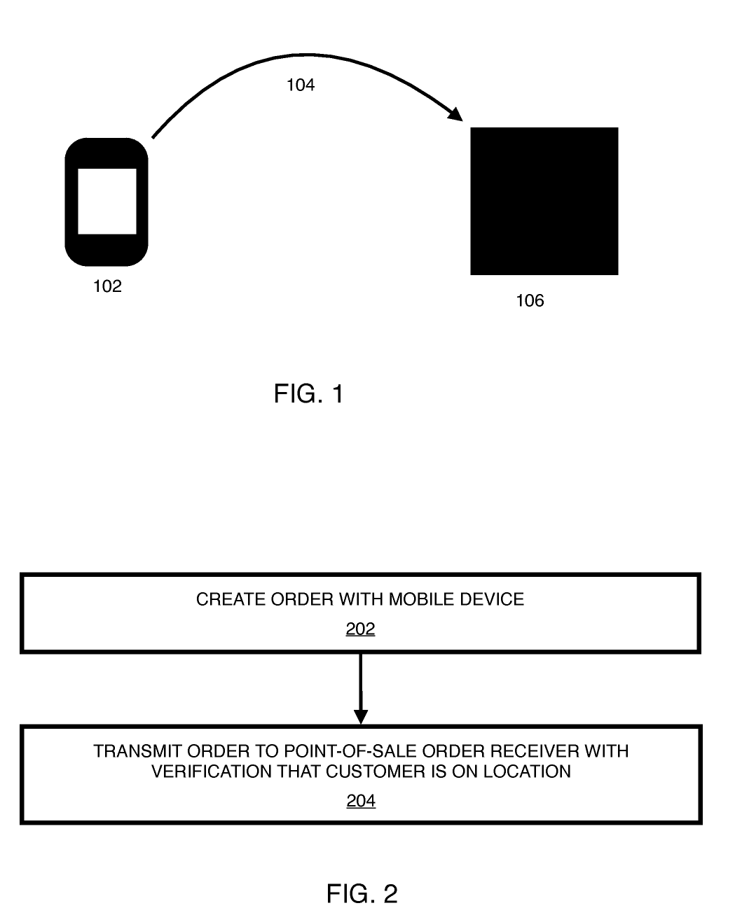

Referring to FIG. 1, a system for using a mobile communication device 102 for placing an order with an order receiver is shown 106 is illustrated. The order is communicated 104 from the mobile communication device 102 to the order receiver 106.

Referring to FIG. 2, a method for using a mobile communication device 102 for placing an order with an order receiver 106 is illustrated. In step 202, a user creates an order with the mobile communication device 102. The user may use the mobile communication device 102 to retrieve information about a merchant. The retrieved information may come from a number of sources, including, for example, the merchant's website or the order receiver 106. For instance, the merchant may be a fast food restaurant. The user may select the restaurant from a list, enter the restaurant into a text box, or use any known method for inputting the name of the merchant into the mobile communication device 102. Another method of selecting a merchant may be for the system to use a position locator, such as the Global Positioning System (GPS), to locate the mobile communication device 102 and determine which merchant the user is patronizing. If more than one merchant is in the vicinity, the system may generate a list and allow the user to select the correct merchant. Once the correct merchant is selected, the user may use the mobile communication device 102 to retrieve information about the merchant. In the fast food restaurant example, the user may use the mobile communication device 102 to retrieve the restaurant's menu. The restaurant's menu may come from, for example, the restaurant's website. With the restaurant's menu, the user may be able to see and select menu items and see prices. In addition to selecting listed items, the system may use any known method of inputting information into a mobile communication device 102 to input an order. The order receiver 106 may be located, for example, in the restaurant's drive-thru line, anywhere inside the restaurant, or in the parking spot of a drive-in restaurant.

In step 204, the created order is transmitted to the order receiver 106. The system also verifies that the customer is on the merchant's premises. Verification can happen in a number of ways, including, for example, physically touching the mobile communication device 102 with the order receiver 106, scanning the mobile communication device 102 with the order receiver 106, sending the GPS location of the mobile communication device 102 with the order 104, or any other known method confirming that the mobile communication device 102 is on the premises. When the communication is through near field communication, verification that the user is on the premises is accomplished by the fact that the communication cannot happen remotely. The user may also include payment with the order. Payment may be made with any known method of payment transfer, such as, for example, credit card, debit card, or PayPal. The order receiver 106 may send information back to the mobile communication device 102. If, for instance, the merchant is a deli, the order receiver 106 may receive the order 104, and then send a customer number back to the mobile communication device 102. A worker at the deli may yell out the customer number once the order is ready for pick up.

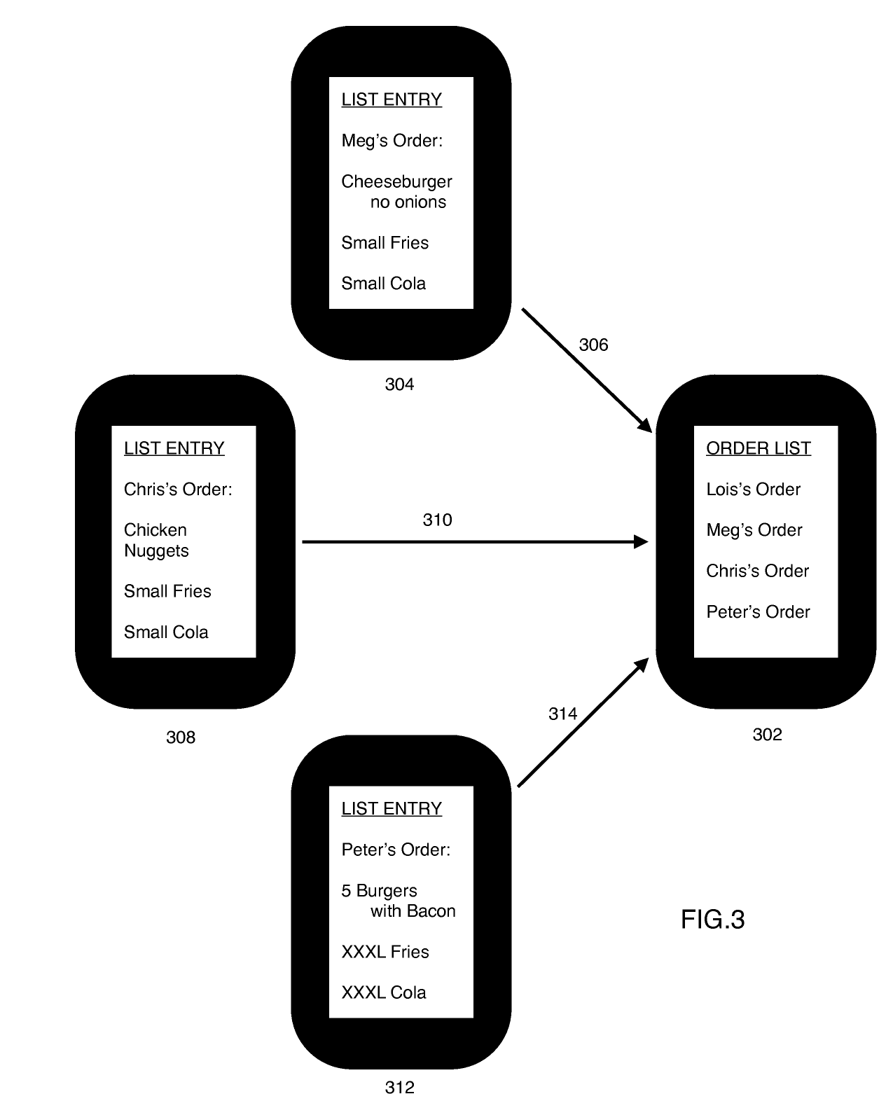

Referring to FIG. 3, a system for collecting order information from one or more sources 304, 308, 312 with a mobile communication device 302 is illustrated. The sources 304, 308, 312 may be any known device capable of communicating with a mobile communication device 302—including, for example, another mobile communication device or any known computer. The mobile communication device 302 will use the received order information, along with any order information that the mobile communication device 302 user may have entered, and construct an order. Along with order information, payment information may also be transferred when the order information is transmitted 306, 310, 314 to the mobile communication device 302. The system may be used, for example, by workers in an office. A first office worker may have volunteered to pick up lunch for the other workers in the office from a fast food drive-thru or drive-in. The first office worker puts the first office worker's order in the mobile communication device 302. A second office worker may enter the second office worker's order into a source 304 and transfer the order information 306 into the first office worker's mobile communication device 302. The system may also calculate how much the second office worker owes for the second office worker's order. The system may calculate a price total from the food based on the restaurant's menu and a local sales tax on food. The system may also calculate how much the first office worker is owed for gasoline. One exemplary way of calculating gasoline cost per person is by tracking gasoline or oil prices, arriving at a total cost of used gasoline by multiplying the price of gasoline or oil by the the gasoline spent—which may be calculated by multiplying the estimated miles per gallon by the distance to and from the restaurant, and dividing total the cost of the used gasoline by a number of office workers. The system may calculate, for example, that the second office worker's food will cost $4.25 and the gasoline spent will cost $0.75. The second office worker may pay by a number of ways. The second office worker may send the second office worker's credit card information to the mobile communication device 302 and only authorize the first office worker to spend the $4.25 for the second office worker's corresponding order and $0.75 for the next time the first office worker goes to the gas station. Alternately, the second office worker may transfer $5.00 from the second office worker's PayPal account into the first office worker's PayPal account. Alternatively, the second office worker may debit money out of the second office worker's debit account and credit the amount in the first office worker's checking account. Alternatively, any other combination of known methods of payment transfer may be used to transfer the money from the second office worker to the first office worker.

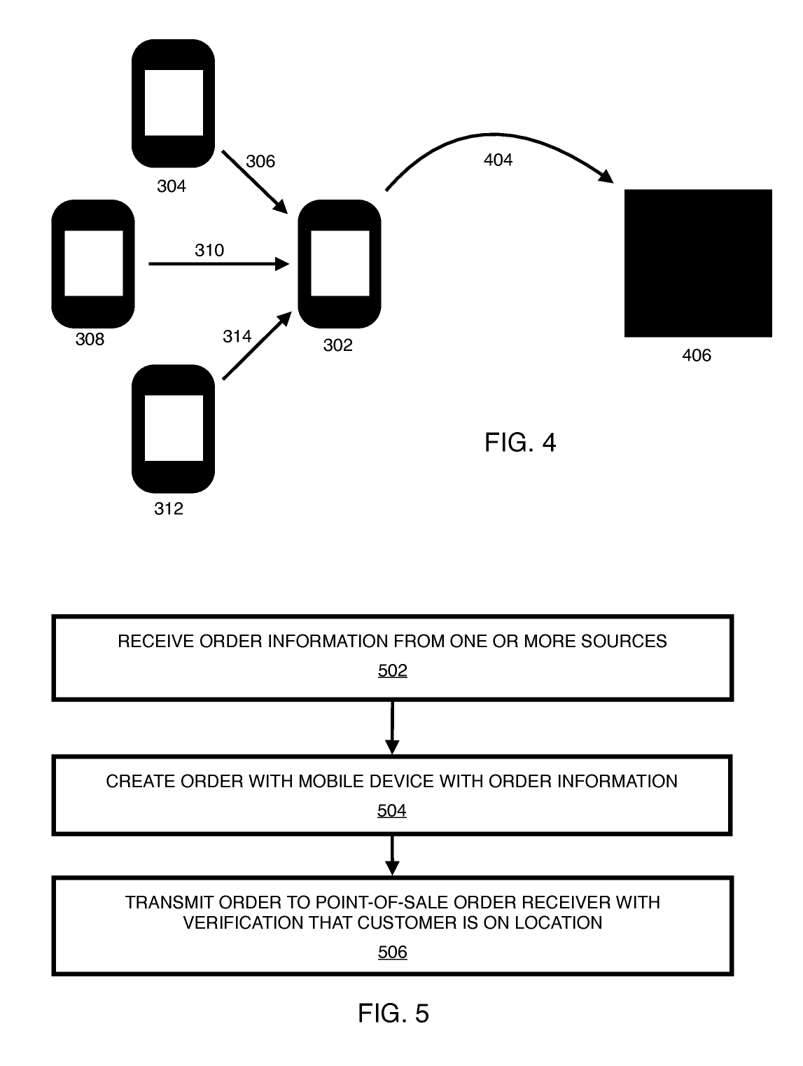

Referring to FIG. 4, a system for collecting order information from sources 304, 308, 312 and transferring 306, 310, 314 the order information to a mobile communication device 302—where the order information is used to construct an order and the order is transferred 404 to an order receiver 406 is illustrated.

Referring to FIG. 5, a method for using a mobile communication device 102, 302 to receive order information 306, 310, 314 from one or more sources 304, 308, 312, organizing the order, and then transmitting 404 the order to an order receiver 406. In step 502, a mobile communication device 102, 302 receivers 306, 310, 314 from one or more sources 304, 308, 312. In step 504, the mobile communication device 102, 302 uses the order information to create an order. The order may consist of several separate individual orders. Payments may be made with the order. And payments may be coupled with the individual orders in any combination. In step 506, the order is transmitted 104, 404 from the mobile communication device 102, 302 to an order receiver 106, 406.

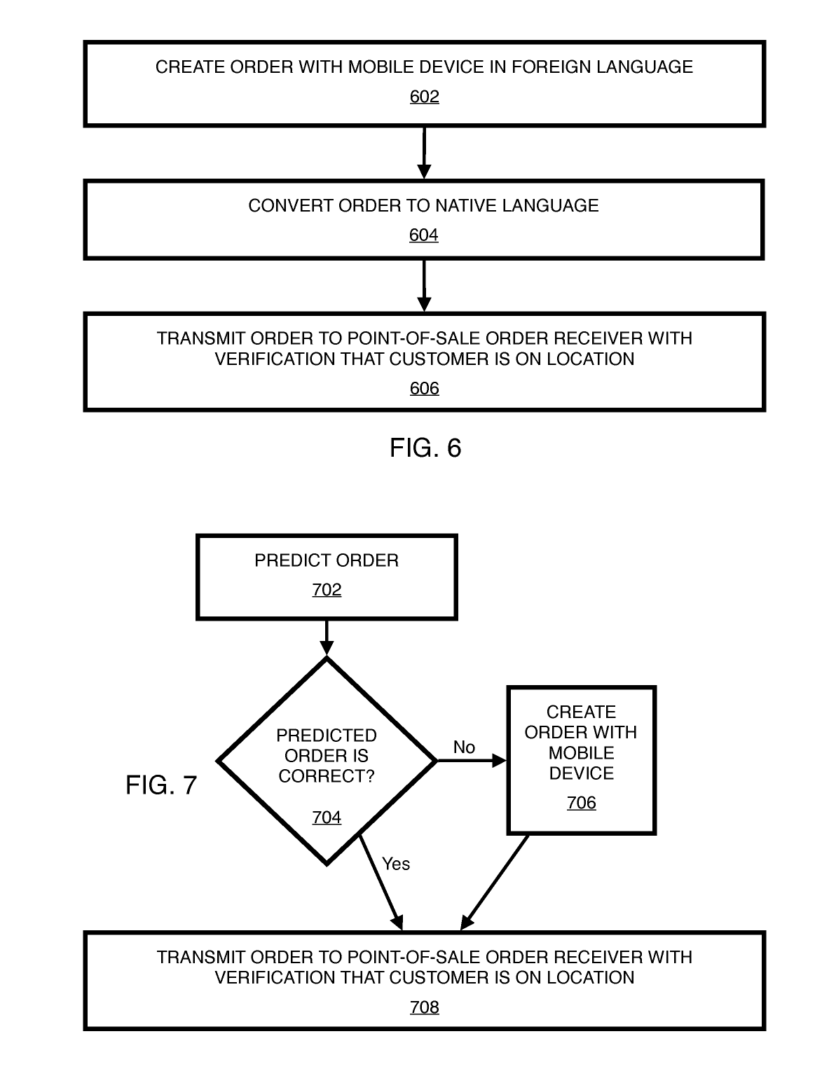

Referring to FIG. 6, a method for using a mobile communication device 102 to create an order in one language and transmit the order 104 to an order receiver 106 for a merchant that deals in another language. In step 602, an order is created with a mobile communication device 102 in a foreign language. The mobile communication device 102 may, for example, retrieve a product list in a native language and convert the product list to a foreign language. The mobile communication device 102 also may retrieve the product list in a foreign language. Any other known method taking a product list that is normally in a native language and displaying the product list in a foreign language on a mobile communication device 102 may be used. The mobile communication device 102 may also display a product list in a native language and allow a user to enter an order in a foreign language. In addition to languages, the method display other information that would normally appear in a native format and display that information in a foreign format on the mobile communication display 102. For instance, the mobile communication device 102 may display a foreign currency value equivalence of a native price, foreign dress size equivalent of a native dress size, etc. After the product information is retrieved, a user may create an order in a foreign language. Alternatively, a user may simply type an order in a foreign language in a mobile communication device 102.

In step 604, the order is converted from the foreign language to the native language. In an alternative embodiment, this step may be performed in the order receiver 106 after the order is transmitted 104 from the mobile communication device 102.

In step 606, the order is transmitted 104 from the mobile communication 102 to the point-of-sale order receiver 106. In an alternative embodiment, an order in a foreign language may be transmitted 104 to a point-of-sale order receiver 106 from a mobile communication device 102 and then the order is converted to a native language, as in step 604.

Referring to FIG. 7, a method for using a mobile communication device 102 to transmit an order 104 to a point-of-sale order receiver 106 that was predicted. In step 702, an order is predicted. The method may predict a merchant by using a position locator, such as GPS. The method may predict an order by using a clock and predicting a merchant. For instance, the method may determine that the user is at a certain fast food restaurant. The method may predict that the user wants to order breakfast at the restaurant, if the time is before 10:30 AM. The user may have ordered two breakfasts in the past, one when the user is by himself and another order when the user is with a friend. The method may use algorithms that take into account factors, such as, for example, how frequent an order is placed, how recent an order was placed, past trends for this day of the week, other past trends, etc. Alternatively, instead of returning one predicted order, the method may return a list of predicted orders, and may list them in the order that the method predicts the user would select them.

Additionally, the mobile communication device 102 may try to predict the user or users present to predict an order. For instance, the mobile communication device 102, may, for example, play music. Certain playlists may be associated with certain users. The mobile communication device 102 may associate certain orders with certain users or user profiles. If the mobile communication device 102, has recently played songs from a playlist associated with one user profile, the mobile communication device 102 may predict an order associated with that user profile. If songs from two playlists are recently played and each song associated with a different user profile, the mobile communication device 102 may retrieve an order for each of the profiles and predict an order for both users associated with the profiles.

In step 704, the user may confirm the predicted order or indicate that the predicted order is incorrect. If the predicted order is correct, the next step is step 708. In the predicted order is incorrect, the next step is 706. If the method returns a list of predicted orders, the user may either indicate that one or more of the predicted orders is correct, or indicate that none of the predicted orders are correct.

In step 706, the user corrects the predicted order. The user may indicated that the predicted order is close and that the user wants to keep the predicted order as a baseline and edit it to get the correct order. For example, the predicted order may be what the user usually orders. The user may want that, but the user may also want to order something additional for her friend.

The user may also indicate that the predicted order is incorrect and wants the method to predict it again. For example, a user may go to a restaurant by herself or with her spouse. When the user goes by herself, the user always orders the same thing. When the user goes with her spouse, both the user and her spouse always order the same thing. The method initially predict that the user wants the order she would place when she is by herself. The user may be with her spouse and indicate that she wants the method to predict a different order.

The user may also indicate that the predicted order is incorrect and wants to enter an order herself.

In step 708, the user transmits the correct order and confirmation that the user is on location 104 to a point-of-sale order receiver 106 from a mobile communication device 102.

In addition to predicting orders, the method may allow the merchant to place suggestions for the user's order. Additionally, the merchant may send special offers to mobile communications devices. Additionally, the mobile communications device may be used to keep track of the user's patronage with the merchant. The mobile communications device may be used in the place of a traditionally loyalty card. For instance, the mobile communications device may indicate that the user gets each tenth sandwich for free after the user orders nine sandwiches, and the mobile communications device may keep up with how many sandwiches the user orders.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system of other apparatus adapted for carrying out the methods described herein is suited. A typical combination of hardware and software may be a mobile communication device with a computer system with a computer program that, when being loaded and executed, controls the computer system such that it carries out the methods described herein. Another typical combination may be a general-purpose computer system with a computer program that, when being loaded and executed, controls the computer system such that it carries out the methods described herein. Another typical combination may be both a mobile communication device with a computer system with a computer program that, when being loaded and executed, controls the computer system such that it carriers out the methods described herein and a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A system, comprising:
a mobile communication device, comprising:
a user interface, allowing a user to enter, select, or confirm order information, and
a near field communication transmitter, capable of transmitting order information; and
an order receiver in a drive-thru, comprising:
a near field communication receiver, receptive to the order information transmitted from the mobile communication device.

2. (canceled)

3. The system of claim 1, wherein the near field communication transmitter is a near field communication transceiver.

4. The system of claim 1, wherein the near field communication receiver is a near field communication transceiver.

5. The system of claim 1, wherein the user interface suggests order information based on at least one of the following factors: location, time, and user profile.

6. The system of claim 1, wherein the user enters the order information in a foreign language and the order receiver translates the order into a native language.

7. The system of claim 1, wherein the user enters the order information in a foreign language and the mobile communication device translates the order into a native language.

8. The system of claim 1, wherein order information includes order information received from one or more other mobile communication devices.

9. A method, comprising:
suggesting order information based on at least on of the following factors: location, time, and user profile,
receiving confirmation or correction of the suggested order information, and
transmitting order information via near field communication to an order receiver in a drive-thru.

10. The method of claim 9, further comprising:
receiving order cost information.

11. (canceled)

12. (canceled)

13. The method of claim 9, further comprising:
translating the order information from a foreign language into a native language.

14. The method of claim 9, wherein order information includes order information received from one or more mobile communication devices.

15. A mobile communication device, comprising:
a user interface, allowing a user to enter, select, or confirm order information, and
a near field communication transmitter, capable of transmitting order information to an order receiver in a drive-thru.

16. The mobile communication device of claim 15, wherein the near field communication transmitter is a near field communication transceiver.

17. The mobile communication device of claim 15, wherein the user interface suggests order information based on at least one of the following factors: location, time, and user profile.

18. The mobile communication device of claim 15, wherein the user enters the order information in a foreign language and the mobile communication device translates the order into a native language.

19. The mobile communication device of claim 15, wherein order information includes order information “received from one or more other mobile communication devices.

20. An order receiver, comprising:
a near field communication receiver, receptive to order information transmitted from a mobile communication device,
wherein the order receiver is in a drive-thru.

21. (canceled)

22. The order receiver of claim 20, wherein the near field communication receiver is a near field communication transceiver.

23. The order receiver of claim 20, wherein a user enters the order information in a foreign language and the order receiver translates the order into a native language.

24. The order receiver of claim 20, wherein order information includes order information received from one or more mobile communication devices.
